(19) United States
(12) Patent Application Publication
(10) Pub. No.: US 2018/0218381 A1
(43) Pub. Date: Aug. 2, 2018

(54) POINT OF SALE CONSUMER REVIEW SYSTEM

(71) Applicant: Jean Paul Pereira, West Sacremento, CA (US)

(72) Inventor: Jean Paul Pereira, West Sacremento, CA (US)

(21) Appl. No.: 15/887,373

(22) Filed: Feb. 2, 2018

Related U.S. Application Data
(60) Provisional application No. 62/453,885, filed on Feb. 2, 2017.

(51) Int. Cl. G06Q 30/02; G06Q 20/20; G06Q 20/32; G06Q 30/06

(52) U.S. Cl. CPC G06Q 30/0203; G06Q 30/0601; G06Q 20/322; G06Q 20/20

(57) ABSTRACT

Embodiments described herein provide for a consumer review system wherein a consumer purchases a product from a provider using a point of sale system. A survey is generated and provided to the consumer for execution. Once executed the survey is displayed on a media outlet. Meanwhile, survey and purchase data is transmitted to the financial institution of the user such that the financial institution may assign a credit to the consumer.

### CROSS REFERENCE TO RELATED APPLICATION

This application claims priority to U.S. provisional application 62/453,885 filed Feb. 2, 2017 which is hereby incorporated by reference.

### FIELD

The present invention is related to systems and methods for obtaining information regarding consumer experiences, and more specifically, to methods and systems for obtaining consumer reviews of products or services.

### BACKGROUND

With the increasingly prevalent use of the internet, society has gained convenient way to aggregate large amounts of data which can be accessed by anyone with network connectivity. While this influx of information has provided a free flow of information across the world at the touch of a fingertip, fidelity of the information has always been a concern resulting in confused users throughout the network.

An example of the above can be seen throughout internet-based review forums such as Yelp. In these implements, users can access a review platform and submit a review and rating of most any service. The underlying issue is the relevance and accuracy of the review. These services typically do not have a means of verifying if the customer ever engaged with the service. Further, some reviewers may have a skewed opinion of a service between the time the service was engaged, and the time the review was generated. Even more, details of the review such as specific names, items, and quantities may have been forgotten in this time period rendering an inaccurate and untrustworthy review.

Services such as Amazon provide a program where purchases are confirmed which ensures that a customer who submits a review on their web site actually purchased the product. While this is useful, it does not require the consumer to review immediately upon the purchase of an item.

Thus, consumer, and manufacturers are deprived from adequately benefiting from the experiences of the vast number of prior consumers. It can be seen that advancements related to consumer reviews is warranted. One such advancement is described in a variety of embodiments herein.

### SUMMARY OF THE INVENTION

Embodiments described herein provide for a system and method for generating a survey related to purchase transactions between a consumer and provider. A method is comprised of a consumer purchasing a product via a point of sale system followed by purchase details being transmitted to a financial institution related to the specific consumer. Once the survey is completed by the consumer, the survey is displayed on a media outlet. To incentivize the systems utilization, the financial institution may reward the consumer for executing the survey by applying a predetermined amount of credits to the financial account corresponding to the purchase implement of the consumer. A purchase database may be utilized to track and store data related to consumer purchases.

In an embodiment, the point of sale system may be the electronic device of the consumer. This may allow the provider to transmit the survey to the consumers electronic device for execution following a purchase of a good or service.

In an embodiment, the survey may be generated in real time in correspondence with the purchase of a good or service.

A system for a client provider interaction may comprise a point of sale system configured to permit a consumer to make a purchase from a provider as well as a financial institution configured to receive purchase data from the point of sale system via a server. A survey is generated by the merchant and displayed to the consumer such that the consumer executes to the survey. A media outlet displays the completed survey permitting the public to access an aggregation of surveys from consumers who have engaged with the particular provider. Lastly, a credit value is assigned to the consumer's financial institution account related to the specific purchase made.

In an embodiment, a table stores at least one entry for each response to the survey and another table that stores at least one entry for each detail of the purchase data that is associated with each question. Each entry in each table is associated with a particular purchase transaction.

In an embodiment, the system may also be comprised of a purchase database related to the consumer.

In yet another embodiment, the consumers electronic device may serve as the point of sale system as well as the survey platform.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a schematic representation of the consumer review system, according to an embodiment of the present invention;

FIG. 2 illustrates a schematic representation of the consumer review system, according to an embodiment of the present invention;

FIG. 3 illustrates a schematic representation of the consumer review system, according to an embodiment of the present invention;

FIG. 4 illustrates a flow chart of the consumer review method, according to an embodiment of the present invention;

FIG. 5 illustrates a flow chart of the consumer review system, according to an embodiment of the present invention; and

FIG. 6 illustrates a flow chart of the consumer review system, according to an embodiment of the present invention; and

FIG. 7 illustrates an exemplary survey questionnaire, according to an embodiment of the present invention.

### DETAILED DESCRIPTION

The specific details of the single embodiment or variety of embodiments described herein are set forth in this application. Any specific details of the embodiments are used for demonstration purposes only and no unnecessary limitation or inferences are to be understood therefrom.

Any reference to “invention” within this document is a reference to an embodiment of a family of inventions, with no single embodiment including features that are necessarily included in all embodiments, unless otherwise stated. Furthermore, although there may be references to “advantage's” provided by some embodiments, other embodiments may not include those same advantages, or may include different advantages. Any advantages described herein are not to be construed as limiting to any of the claims.

As used herein, relational terms, such as “first” and “second” and the like, may be used solely to distinguish one entity or element from another entity or element without necessarily requiring or implying any physical or logical relationship or order between such entities or elements.

Specific quantities, dimensions, spatial characteristics, compositional characteristics and performance characteristics may be used explicitly or implicitly herein, but such specific quantities are presented as examples only and are approximate values unless otherwise indicated. Discussions and depictions pertaining to these, if present, are presented as examples only and do not limit the applicability of other characteristics, unless otherwise indicated.

The invention can be implemented in numerous ways, including as a process; an apparatus; a system; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

In general, Embodiments of the invention described in this specification relate generally to gaining customer reviews at the point of sale by collecting review data from the point of sale system, terminals or credit/debit card bank alerts and displaying it on a public website, smart device application or forum. Typically people use standard review websites and mobile applications to issue consumer reviews about products and services.

Therefore, what is needed is a new system where people will be able to quickly be prompted to review a company at the point of sale or from credit/debit card alerts via smart device or smartphone. By creation of a system like this, the reviews are more secure and likely more accurate. False reviews would be curtailed from this more secure system.

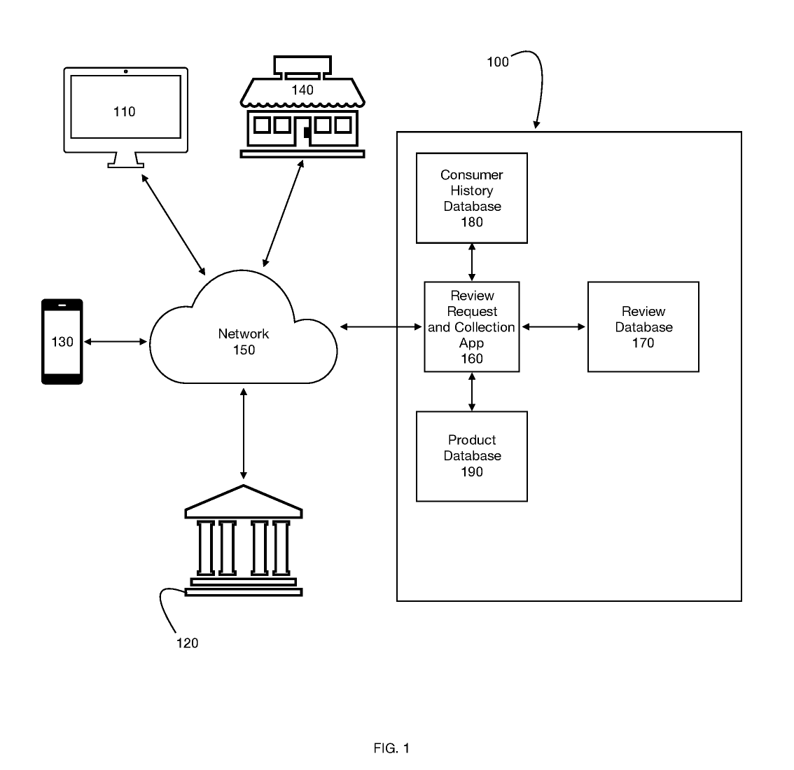

In specific reference to FIG. 1, a schematic of the network configuration is shown in an embodiment of the present invention. Network 150 permits the the communication of various user devices 110, 130, and the provider 140, whether they may be primary consumers or those simply viewing the purchases and surveys submitted by other consumers. Each device may include a personal electronic device (“PED”) such as a cell phone, PDA, Tablet, or laptop as well as desktop computers and any other device having network connectivity capabilities. The financial institution 120 is in communication with each user as well as the system 100.

System 100 may be comprised of a review/request and collection application which generates and transmits relevant reviews to the consumer 130 as well as transmits review status and funds to the financial institution 120. A product database 190 may store data related to each purchase made by each consumer utilizing network 150. Specific consumer history may be stored in the consumer history database 180 to be utilized by external users, financial institution 120, and providers alike. A review database 170 may store reviews provided by any user within network 150 such as the provider 140.

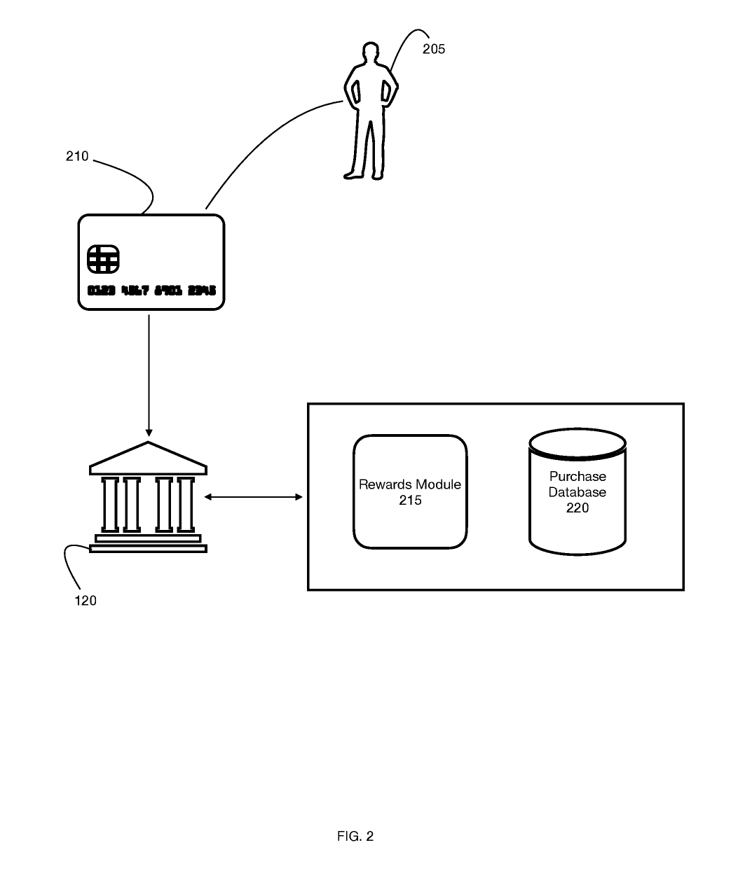

Referencing FIG. 2, consumer 205 utilizes payment implement 210 to purchase a good or service from provider 140. As described herein, the payment implement may include a credit or debit card, smart device payment systems known in the arts, rewards cards, gift cards, or other implements. The financial institution 120 may be in communication with a rewards module 215 and purchase database 220. The rewards module functions to provide the consumer with an increased reward for each purchase made, preferably upon the successful completion and submission of a survey generated by the system 100.

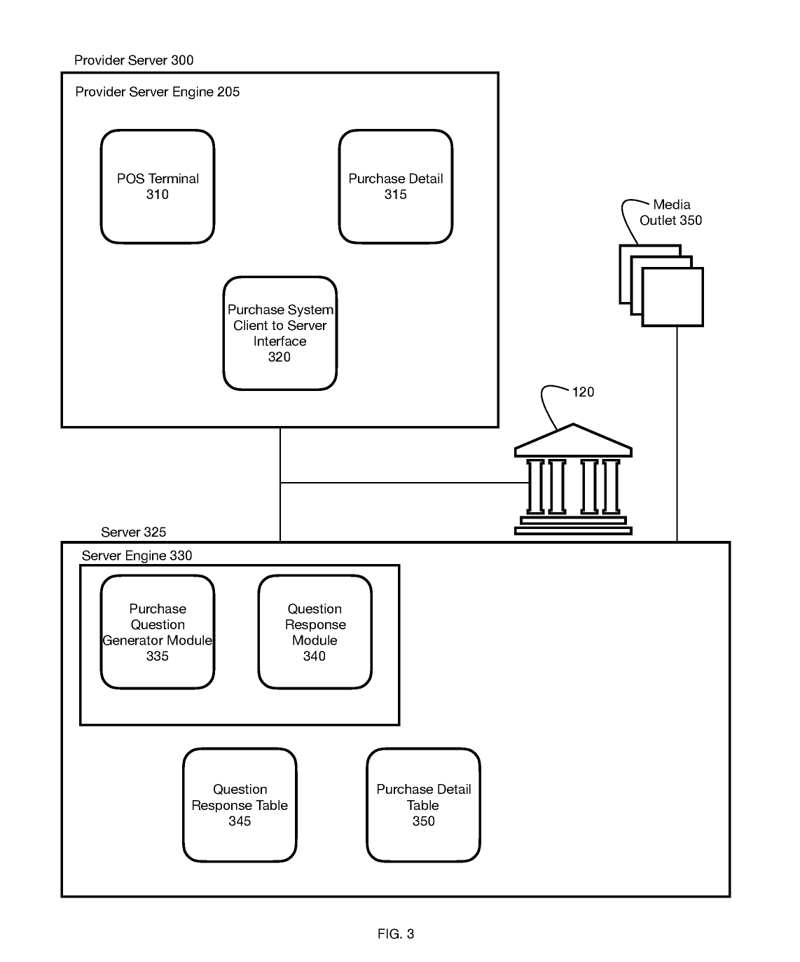

Now referring to FIG. 3, a schematic of the system is illustrated in yet another embodiment of the present invention. Financial institution 120 is in communication with a provider server 300 configured to transmit data related to the provider POS terminal 310, purchase details 315, and the purchase system client to server interface 320. The POS terminal may be any terminal used in the arts including network connected devices such as commercial POS systems. The POS system 310 may also be defined as the consumers own personal electronic device wherein the device is utilized to execute the transaction. Purchase details 315 may include the data and time of purchase, specific item purchased, and the monetary amount and item quantity purchased thereof.

Server 325 and server engine 330 may transmit data generated by purchase question generator module 335 and question response module 340. In an embodiment, a question response table 345 stores at least one entry for each response to the survey and purchase detail table 350 stores at least one entry for each detail of the purchase data that is associated with each question. Each entry in each table is associated with a particular purchase transaction.

In an embodiment, outputs of server 325 may be transmitted to any number of media outlets 350 to be viewed by the public. Media outlets may include any computer readable medium such as blogs, webpages, mobile applications as well as printed publications as known in the arts.

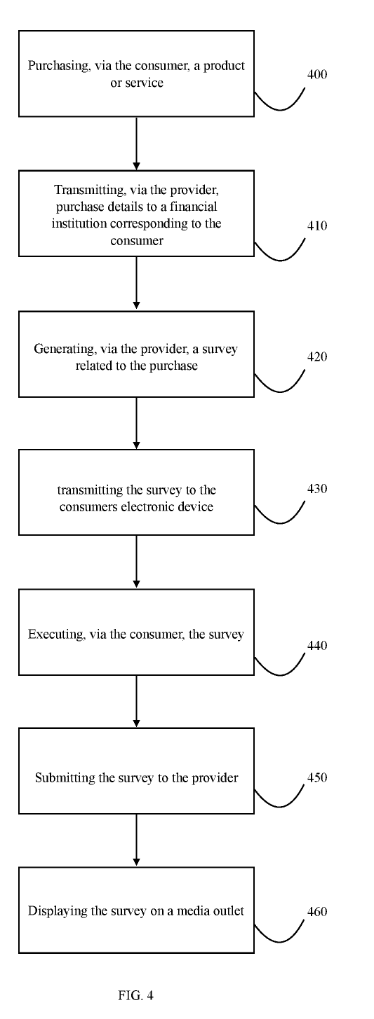

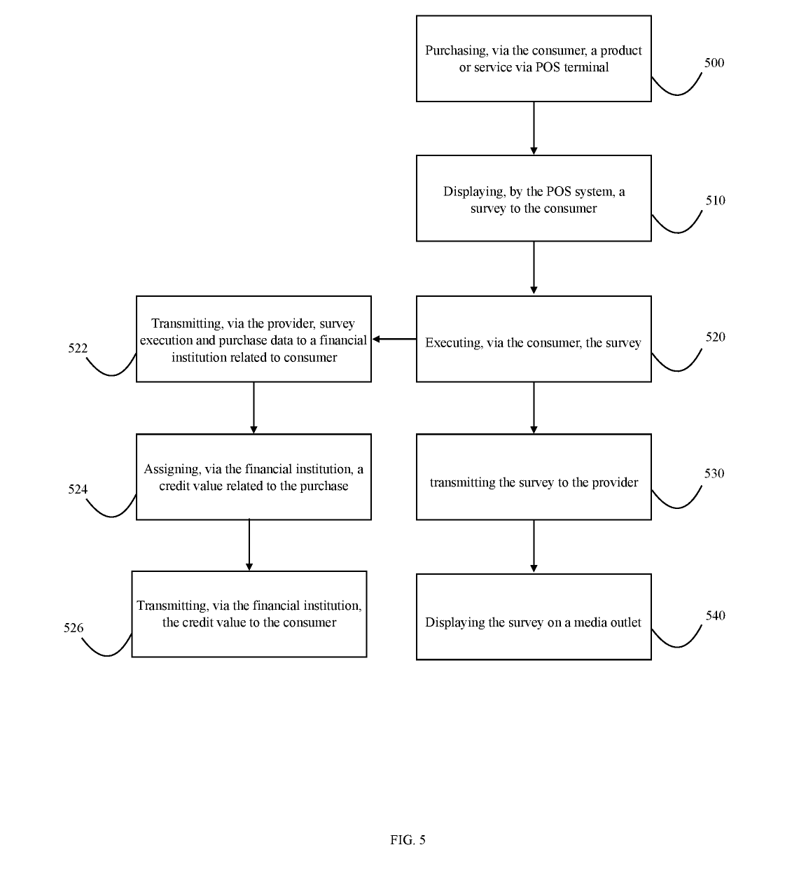

Each of FIGS. 4 and 5 relate to methods in embodiments of the present invention permitting the rewards generation following a survey my a consumer. Specifically relating to FIG. 4, in step 400 a consumer purchases a product utilizing a point of sale system. In step 410 the provider transmits purchase details to a financial institution corresponding to the consumer followed by the provider generating a survey and providing the survey to the consumer electronic device in steps 420 and 430. In step 440, the consumer executes the review and in step 450 the executed survey is submitted to the provider. Lastly, in step 460, the survey is displayed on a media outlet for public viewing.

At any time during steps 400-460, the financial institution may apply a credit or reward to the consumer contingent on the completion of the review. The rewards module 215 may generate an appropriate credit or reward educated by the transaction details.

FIG. 5 illustrates an alternate embodiment of the method utilized by the system. In step 500, the consumer purchases a good or service via the POS terminal. In step 510 the POS terminal displays a survey generated by the purchase question generator module 335 or similar implement. In step 520 the user executes the survey using the POS terminal and transmits the executed survey to a financial institution in step 522. The financial institution the assigns a credit value to the consumers account in step 524 and transmits this value to the consumer account in step 526. Meanwhile, the completed survey is transmitted to the provider in step 530 and the completed survey may be displayed on any media outlet in step 540.

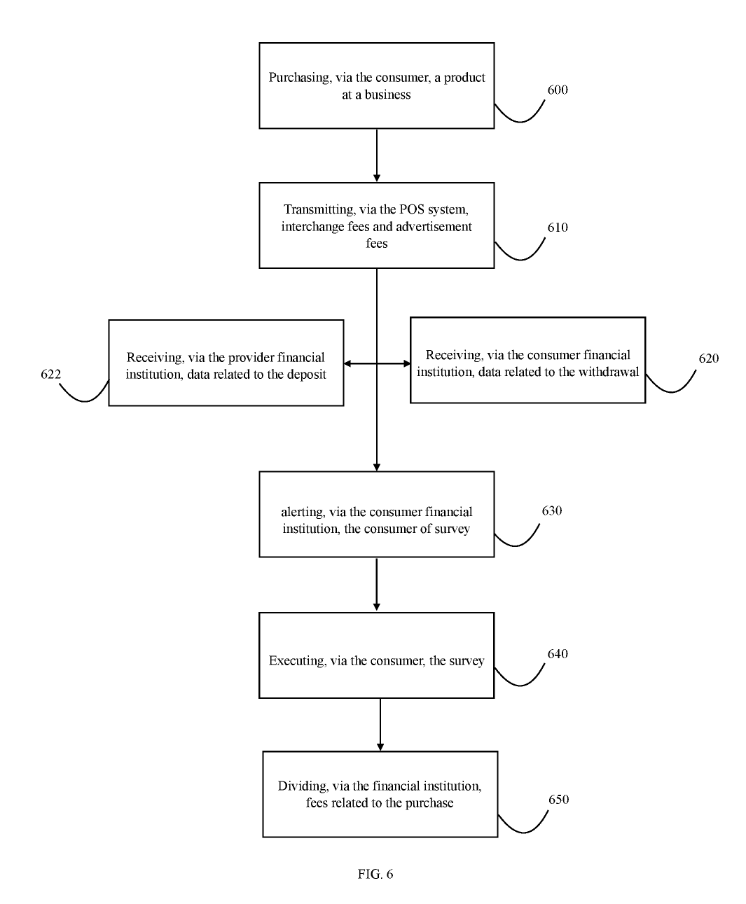

FIG. 6 illustrates yet another embodiment of a method related to the automated consumer review/survey system. In step 600 the consumer purchases a product or service at a provider storefront. This may be accomplished using a POS system or similar implement. In step 610 the payment gateway or POS system transmits interchange fees and advertising fees followed by the provider and consumer financial institutions receive withdrawal and deposit data in steps 620 and 622. In step 630, the consumer financial institution alerts the consumer to a generated review and in step 640 the consumer may execute the survey. In step 650 fees are divided among recipients followed by the survey provider being compensated from these fees. Fees may include bank fees, consumer credits as a percentage, POS system fees, and survey fees.

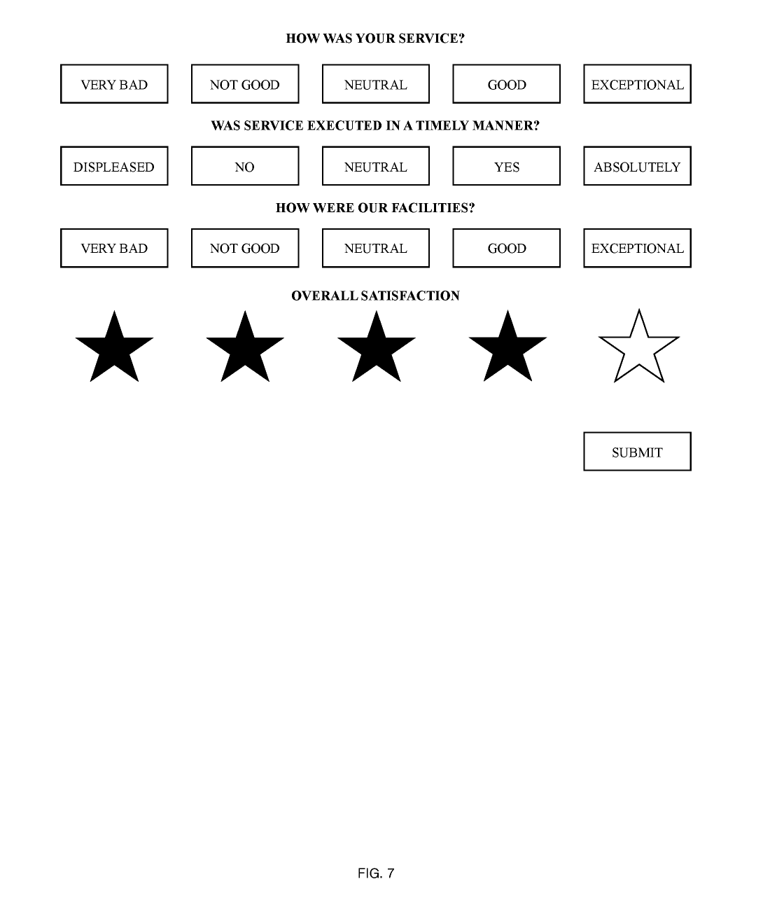

While any configuration of survey may be utilized, FIG. 7 illustrates an embodiment of the survey having a plurality of survey questions, survey answer selections, and a submit feature. The survey may be in the form of a questionnaire as illustrated having any number of questions or ratings implements. These questions may be presented as the survey on the GUI to the consumer upon the completion of a transaction. This may generate data including amount of questions answered, time taken to answer, as well as data related to each specific question.

Some embodiments of the invention include a novel system that takes the reviews from customers from the point of sale terminals, credit/debit card partnerships, debit, reward card, credit card alerts, smart device pay systems like Apple Pay etc. or from merchant sales receipts and logs them to a dedicated website where people can make informed decisions about that particular business, service or product purchased. The way it can be monetized would be through charging the provider (e.i. merchant) or merchant service gateway an additional rate to their current rate or charge the business for advertising directly. Currently credit/debit cards offer rewards for use of their credit/debit card and credit/debit card companies charge a percentage to the business owner to cover these reward programs, then distribute points to their cardholders after they charge the business owner. The use of the credit/debit card, bankcard, mobile wallets and cryptocurrency wallets is essential to making this system work because the system would work or integrate with bankcard systems from credit/debit card, mobile wallets, cryptocurrency companies and they would send out alerts on behalf of the system or application of the system with permission of the bankcard company or bank card holder would send out the alerts to smart devices, smart phones, desktop computers, laptop computers and smart tablets in the form of a push button alert, email, SMS/MMS message or text message. The message would prompt the person who is receiving the alert to leave a review for the business, service, and product that was purchased. It is also essential that the merchant gateway will relay the purchase to the bank card holder. So by adding an additional percentage points to the sale to the merchant, the review system would then be able to offer additional rewards points to the bank card holder when they complete the review or survey.

In reference to FIG. 1

In an embodiment, reviews are collected from the point-of-sale (“POS”) terminals from merchant accounts and customer receipts that can be directly entered on the terminal or scanned into the system. Further, the capability of the smart device to capture an image of the review and utilize optical character recognition (“OCR”) may be utilized to convert the writing to text data. This review data is then gathered by the affiliates and transmitted to the media outlet.

Media outlets may include any publicly available materials such as a website, applications, and forums thereon. Other media outlets may be utilized as known in the arts to permit the public publication of review data.

In an embodiment, Data would be gathered to make the review process easier such as receipt information about the items purchased, name, address, website address, email address phone number of the business.

Once a purchase has been made, the consumer may receive an alert on their PED informing the consumer of data related to the purchase including purchasing location, provider name, amount of purchase, and an option review for the specific purchase. At this point, the consumer can compile and submit a review, survey, or similar submission. This may be directed toward the provider, services rendered, and/or product purchased as well as any combinations thereof.

In an example, the review within the graphical user interface (“GUI”) may ask a plurality of questions such as:
a) Was a product or service purchased?
b) What type of product/service was purchased?

In the example above, each question may produce a search query on the GUI permitting the user to search a database of listed items which may have been purchased. In this manner, any search engine may be utilized to identify the product or service. Once the product/service is displayed in the search query, the consumer selects the product and is given the option to submit a review. Following the review, the submission is published on the media implement. This review may be related to any of the following:
a) Customer service
b) The product(s) and service(s)
c) Cleanliness/organization
d) Wait times
e) Location and safety
f) Overall satisfaction

In an embodiment, the consumer may then be presented the option to register a warranty or rebate for the purchased product. This may transfer the consumer to an appropriate website to complete the warranty/rebate process.

Wherein a user is submitting a review for a specific service, a more general view of the business may be submitted. In this manner, the system may modulate questions based on any number of characteristics including type of product or service provided.

In an embodiment, the consumer receives additional points or credits with their bank card provider or similar affiliate service for submitting and participating in the review system.

Once submitted, the information and relevant data for the consumer review is transmitted to a public website, web application, smartphone application, forum, or similar media outlet for other consumers (remote consumers) to engage therewith.

Those skilled in the arts may appreciate that the invention described herein may be monetized in plurality of ways. For example, the system may be monetized by utilizing an extra applied rate assessed to the business for every transaction to their current merchant account and through direct business advertisement on the website and smart devices application.

The user platform may be comprised of a GUI having any number of features. While many of these features are described herein, the following description serves to provide exemplary embodiments of the GUI. Each page provides for exemplary embodiments of the GUI without limiting each page, or the interface as a while. Some embodiments may include: a login or signup page, signup form page, password setup page, password retrieval page, username retrieval page, and homepage as generally utilized in the arts to permit a user to logon, register, and start the service on a GUI as performed by one or more processors.

User pages: A user or customer page is where the customer can manage their page, see points or money earned, reviews in queue, potential earnings to complete review by deadline before the money expires and account settings such as time, date, hometown, and other personal information such as body size, photos for fitting/measuring when ordering clothing from different sites, favorite places to eat or AI will be able to pick this feature up based on number of visits. Account setting can be adjusted to reflect what type of reviews means the most to the customer and those ratings would show up first when they are logged on searching for a business or if they chose not to adjust this feature then AI will be able to automatically adjust it.

Merchant pages: The merchant pages are where the merchant or business can manage their page, review their Business Report Card and account settings.

A report card may feature:
Customer service rating
The products and service/s rating
Cleanliness and organized rating
Wait times rating
Location and safety rating
Interior décor rating
Overall satisfaction rating
Top selling items
Amount of high end, median and low-end clients based on spending habits.

Administrative pages: The administrative page is the location where the operators of the review site/application can manage the applications for errors and support tickets.

Dashboard page: A dashboard page may display the merchant dashboard or the consumers dashboard depending upon what type of registration the user imputed to the system and would be controlled by username and password.

Support page: The support page may be where the customer or merchant can go to create a support ticket for errors and fixes.

Support tickets page: Where the customer or merchant can go to fill out a support ticket.

Legal terms of use page: Where the customer or merchant for their use could view the legal terms and conditions of the review site/application.

Templates for reviews page: This page is a general page that all information filled in by customer, merchant, or financial institution such as banks, credit/debit card providers, merchant services, payment gateways, mobile wallets and crypto wallets can input their information. Then the page would be ready for public display.

Close of accounts page: This page would be utilized for account closures for businesses/merchants or customers/users.

Identity verification link to email and or secret questions page to ensure fidelity and security of the system.

Trending businesses: A list of popular businesses in the geographically searched area in a certain period of time when they are at their most popular.

By distance: A general search for the business, service or product can be done by the geographical distance in a particular location or nearest location to find the business, service or product of choice by the consumer.

Maps: Google maps, Apple maps, or the choice map of the consumer can be integrated to the system for optimal logistics.

Number of reviews: The system keeps an account of all reviews and the number of reviews is a relevant way to search out a particular type review to satisfy the consumers requests in a particular location or nearest location.

Pick up and delivery: The system would list pick up and delivery of products and services of a particular business.

Advertised discounts: The system would list discounts the business would like to list on their page and on the listed section if they wish to list discounts or products and services.

Check in and check out of a business: Consumers or customers of the business can geographically check in to that location and within the premises of the business.

Categories of different businesses: Categories of different businesses in the system will make it easier to decipher what the customer is searching for as for products and services.

Business hours of operation: Business hours of operation would be listed in the system so the customer would know what time to show up when opening for daily business and when not to show up when close of business day.

Mapping with map pins: Map pin will help place the business on the map application to help the customer navigate to that business. Map pins may also be used for customer location, for their friends to find them at that location.

5 star rating, tally of reviews: Customer would use the popular 5 star rating systems but no limited to that system. The review would be tallied next to the average rating of stars.

Reviews from gifted goods and services: Gifted goods and services can be reviewed in the system but would not be able to take advantage of rewards points.

To ensure fidelity, reviews inputted from non-buyer would be considered unverified.

Price point for a category: The customer can lookup ratings based on price point of what previous customers had rated the business for how much they spent $=0-$9, $$=10-$99, $$$:=100-$999, $$$$=1000-$9,999 and other amounts that would reflect this scale but not limited to this type of monetary scaling.

Business address: Businesses or customers would list where the business is located in the system. The bankcard system could also present the reviewer the address of the business in bankcard alerts. This feature would automate finding the address.

Business phone: Businesses or customers would list what the phone number of the business system. The bankcard system or financial institution could also present the reviewer the phone of the business in bankcard alerts and that data would carry over as soon as a review is started.

Business website and mobile application: Where Businesses or customers would list what the website or mobile application of the business to the “system”. The bankcard system could also present the reviewer the website and mobile application of the business in bankcard alerts and that data would carry over as soon as a review is started.

Social media share with other platforms: The system would feature social media sharing to help customers share on their social media feeds about a business. Plus customers can schedule meetings at these businesses through the social media integration from that social media platforms API.

List form and map form: Businesses would be listed in the short list form in the system with the distance next to business name. The map form would list the business and distance on the map and the customer's location and project distance to the customer. So the customer can find the business from the distance search criteria.

Geo fencing: Geo fencing would be used in the system for advertisement purposes where the business can set geographic area to advertise special offers. Geo fencing may also be used to confirm cardholder transactions to match the time of transaction with there GPS system on their smartphone, smart device, or mobile phone. Geo fence would alert all users with an alert or silent alert depending on the users settings. The alerts would be in list form and have details of the special offers from a plurality of businesses or merchants.

Regional multiple location of business listings: Based on specific searches on the system, the system will list multiple locations of a business or a specific goods and services that are sold amongst similar businesses.

Alerts for favorite businesses and places to go, when deals are offered from those businesses: The alerts would go off as soon as the business list those specials or offers and would also work in the Geo fence as well.

Paid advertisement listings: Businesses would have the option to advertise their goods and services to boost their presence in the community and in the system.

Suggestions: The system would employ artificial intelligence to learn about the customer to make suggestions of what they may like to purchase for goods and services.

Automobile GPS systems: Capability to integrate with a plurality of automobile makers GPS systems and other GPS devices to display businesses and ratings in the area of the driver.

Find friends: System users or customers has the capability to find friends with in the system while being logged in if they chose to let people in their group or friends see where they are located through the GPS in the system.

Messaging: Intersystem messaging and private messaging for friends and to the business owner.

Technical support: Technical support to describe the step-by-step process of the full system.

Filters: Filters to pick what the customer wants to see in their search criteria.

Dashboard queue to postpone reviews: Reviews could be done right away or could be put into a queue to do the review at a later time or before the reward points expire.

Credit and Debit Card registration: Users can register their credit/debit cards and receive alerts to leave a review. With the permission of the customer the system can retrieve information from customers hank statements to send alerts to leave reviews.

Investment and money management applications: Money management applications such as (Acorns as a reference) would be able to report purchases to the system with integration of these applications. To be capable to transfer a plurality of rewards point to investment accounts for purpose of purchasing financial instruments.

Expiration date to do review in queue: though there is no expiration to do the review but the bankcard may have an expiration date to collect the reward points.

Cash back offers: Businesses can list cash back offers in their business listing and in paid advertisements for their goods and services

User account and preferences: Users to have the capability to change and modify their profile and set preference criteria.

Birthday Alerts with offers: Businesses can send intersystem messages to members throughout their region for birthday special offers from businesses in the area for those who disclose there day and month of birth on the system and present location.

Present Location: Can be turned on and off to communicate with the system where they are located for sales offers and deals for goods and services businesses have to offer.

Rebates: Rebates can be offered through the system when logged by the business with hyperlinks to then leave the system to the businesses website to complete the rebate.

Distance matching: The customer can be matched with a business for goods and services with intersystem matching customer with business based on search criteria.

Take-out or delivery: Businesses can list in the system whether they offer take out, delivery service, or strictly dine in for food services.

Group deals: Group deals can be offered in the system for pre-sale of goods and services to customers so they can redeem them at or before the time of expiration. Group deals also may extend to booking an events or tables at restaurants and whatever could be booked in advanced.

Reservations: Reservations could be made in the system to book any type of reservation whether it is at a restaurant or for physical training.

Accepts credit cards: Listing types of payments accepted is important to customers so all type of payments will be listed like Cash, Check, Credit cards, debit cards, Smartphone pay systems like Apple pay, bitcoin or cryptocurrency and trades if the business chooses to do so.

Outdoor seating: For anyone who wants to sit outside of the confines of the business, the business can then list whether they could offer outside seating.

Good for children: a plurality of businesses can list if the venue is good for small children and older for older crowd.

Wheelchair accessible: a plurality of businesses can list if their place of business offers accommodations for the disabled or is American Disabilities Act compliant.

Dogs allowed: a plurality of businesses can list if dogs are allowed in the confines of the business dour business hours.

Vegan: With many people having different dietary needs the business has the option to list special dietary goods of different types of foods for their place of business.

Military and veteran discounts: By paying tribute to those who serve or have served in the military the business can list discounts to military and veterans.

Senior discounts: The business can list discounts to the senior citizen community to ease their fixed income budget.

Suggestion on the way during driving directions or after the visit to the business. Like list gas stations on the way etc.

Total points gained from review submission, an accounting in dashboard login of all points for particular user.

Full bar, happy hour, suggested for breakfast, brunch, lunch, dinner, dessert, late night, live music or DJ, and free Wi-Fi.: Businesses can list the food and beverage times and options like full bar providing not only beer and wine but also liquor. Happy hour—a time when the business is not at its busiest. Breakfast times, brunch times, lunch times, dinner times, dessert options, late night options, live music options, DJ and free WiFi for customers.

General search through system platform: Search criteria to help customers navigate and find businesses throughout the system.

Business response and correction: Businesses can respond to the ratings and comments left by customers whether good or bad. Prior to leaving comments the business can work out differences through private message to the consumer.

In an embodiment, the provider may receive alerts having business metrics. In an example, this may include a report of revenue for each product in the store providing an indication for which items are selling well and which are not. The provider may also receive alerts of similar reviews containing a specific keyword. For example, the provider may receive an alert that more than one negative review has been submitted for a particular product.

In yet another embodiment, artificial intelligence implements may be used to parse surveys permitting the collection of data. This data may be output in monthly reports, weekly reports, or single alerts to users within the system. An alert may be triggered upon more than one similar review or survey is submitted for a particular item. This may permit particular reviews to be displayed in a separate feed for entertainment purposes. In an example, all bad reviews may be displayed in a unique feed.

The provider can select products they wish to get feedback on in there dashboard or they can randomly assign the selected product that will be reviewed. Reviews being randomly selected for products could be introduced to the consumer for review at certain intervals of all transactions during the business day or it can be introduced to the buyer when it is purchased to increase the likelihood of a review on a product.

Voice recognition software: The system can integrate with smartphone features like voice recognition to fill fields.

SMS/MMS Text Review survey questions—Groups of interactive text messages would be capable of completing the review in the customers SMS/MMS text message system. The group of text messages would comprise of questions that would complete a review survey with a hyperlink. When one answer is filled and sent, the system will log the answers to the review system. Then the next question would be texted to the customer to complete that question and this process would go on until the survey or review is finished. Question would not be limited to multiple choice but also fillable text to complete this process.

In an embodiment, the system sends a text or alert to the consumer having payout metrics, including lost rewards or credits if a survey is unexecuted or is executed past the deadline.

Ratings/review to have survey to ask if the review was helpful at end of page of review for other viewers and users to list if it helpful.

Member to member messaging. Video and Photo taking and posting. Find friends on other social networks to invite and from general contacts listed in smart device and logged email contacts. First business review listing. Member to member following, member support, privacy settings, sharing settings, push notifications and email notifications.

Categories businesses can edit their content through their platform login.

Platform imports credentials from other social media sites for fast sign up and sign in.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A method for automatically generating a survey relevant to each purchase transaction and applying a credit therefrom, comprising:
purchasing, via a consumer, a product via a point of sale system;
transmitting, via a provider, purchase details to a financial institution corresponding to the consumer;
generating, via the provider, a survey related to the purchase;
transmitting the survey to the consumers electronic device;
executing, via the consumer, the survey;
submitting the survey to the provider; and
displaying the survey on a media outlet.

2. The method of claim 1, wherein purchase data corresponds to the consumers payment implement account.

3. The method of claim 2, wherein the credits are applied to the payment implement account.

4. The method of claim 1, further comprising a purchase database related to the consumer.

5. The method of claim 1, wherein the point of sale system is supplied by the consumers electronic device.

6. The method of claim 1, wherein the media outlet aggregates a plurality of surveys from a plurality of consumers.

7. A method for consumer and provider interactions comprising:
purchasing, via a consumer, a product with a point of sale system;
displaying, via the point of sale system, a survey to the consumer;
executing, via the consumer, the survey;
transmitting, via a provider, the executed survey and a plurality of purchase data to a financial institution;
assigning, via the financial institution, a credit value related to the purchase data;
transmitting, via the financial institution, the credit value to the consumer;
transmitting the executed survey to the provider; and
displaying the executed survey on a media outlet.

8. The method of claim 7, wherein the survey is generated in real time.

9. The method of claim 7, further comprising the steps of:
automatically generating the survey when the purchase information is received; and
providing the survey upon receipt of the purchase.

10. The method of claim 7, wherein the media outlet aggregates a plurality of surveys from a plurality of consumers.

11. The system of claim 7 further comprising an interface that enables purchase data to move between the consumer and the server.

12. The method of claim 7, further comprising a purchase database related to the consumer.

13. The method of claim 7, wherein the point of sale system is supplied by the consumers electronic device.

14. A system for client and provider interactions comprising:
a point of sale system configured to permit a consumer to make a purchase from a provider;
a financial institution configured to receive purchase data from the point of sale system via a server;
a survey generated by the merchant and displayed to the consumer, wherein the consumer executes to the survey, and wherein the survey is displayed on a media outlet; and
a credit value related to the purchase data, wherein the credit value is assigned by the financial institution and transmitted to the consumer.

15. The system of claim 14 further comprising an interface that enables purchase data to be transmitted between the consumer and the server.

16. The system of claim 14, further comprising a table that stores at least one entry for each response to the survey and another table that stores at least one entry for each detail of the purchase data that is associated with each question, wherein each entry in each table is associated with a particular purchase transaction.

17. The system of claim 14, wherein the media outlet aggregates a plurality of surveys from a plurality of consumers.

18. The system of claim 14, further comprising a purchase database related to the consumer.

19. The system of claim 14, wherein the point of sale system is supplied by the consumers electronic device.

20. The system of claim 14, wherein external consumers may access executed surveys from a plurality of providers.
